(19) United States
(12) Patent Application Publication
(10) Pub. No.: US 2015/0350471 A1
(43) Pub. Date: Dec. 3, 2015

(54) PRINTING APPARATUS

(71) Applicant: SEIKO EPSON CORPORATION, Tokyo (JP)

(72) Inventors: Kiyoshi MUKAIYAMA, Matsumoto-shi (JP); Mamoru AKATSU, Matsumoto-shi (JP)

(21) Appl. No.: 14/722,999

(22) Filed: May 27, 2015

(30) Foreign Application Priority Data
May 29, 2014 (JP) 2014-110948
Apr. 23, 2015 (JP) 2015-088164

(51) Int. Cl. H04N 1/00; G06F 3/12

(52) U.S. Cl. CPC H04N 1/00503; G06F 3/1204; G06F 3/1258; G06F 3/1297; H04N 1/00413; H04N 1/00474

(57) ABSTRACT

A printing apparatus includes a controller that causes a function selecting portion on which a function is selectable to be displayed at a predetermined position, in which the predetermined position is set for each function in advance and the controller displays the function selecting portion of an expanded function at the predetermined position based on attachment of a function expansion device, in a selectable manner.

### BACKGROUND

1. Technical Field

The present invention relates to a printing apparatus.

2. Related Art

Examples of an ink jet printer as a printing apparatus include a single-function printer that specializes in a printing function and a multifunction printer that has multiple image processing functions. For example, JP-A-2007-228035 discloses a multifunction printer that has an image reading function (a scanner) in addition to a printing function (a printer) and is configured to have an image transmitting function (a facsimile) as an option. The multifunction printer includes a communication unit or file transferring unit and a file storage unit and thereby, operations of transferring of information or copying are performed without booting up a computer which is connected to the multifunction printer.

However, the printing apparatus (multifunction printer) disclosed in JP-A-2007-228035 has a problem in that an increase in functions causes operations which are performed corresponding to the functions, operations which are performed to select and execute the corresponding functions, displays of the operation screens, and the like to become complicated. For example, problems arise in that operation is needed for selection or registration of an optional device which is connected, the number of icons which are displayed on an operation panel is increased and then it is difficult to identify the icons, and for example, in a case where a selected device is not connected, a display or handling of the error is needed.

### SUMMARY

The invention can be realized in the following forms or application examples.

### Application Example 1

According to this application example, there is provided a printing apparatus including: a controller that causes a function selecting portion on which a function is selectable to be displayed at a predetermined position, in which the predetermined position is set for each function in advance and the controller displays the function selecting portion of an expanded function at the predetermined position based on attachment of a function expansion device, in a selectable manner.

In this case, the printing apparatus includes the controller that causes the function selecting portion on which a function is selectable to be displayed at the predetermined position, in which the predetermined position is set for each function in advance and the controller can display the function selecting portion of the expanded function at the predetermined position based on attachment of the function expansion device, in a selectable manner. Therefore, it is possible to check whether or not the functions of the printing apparatus are available using the function selecting portion at the predetermined position and it is possible to easily recognize whether the function expansion device is attached and is selectable. As a result, since it is easy to recognize the position of the function which is selected on the display section and the available functions are distinctly displayed, it is possible for the available function to be utilized with a simpler operation.

### Application Example 2

The printing apparatus according to the application example may further include a display section on which the function selecting portion can be displayed, in which the predetermined position may be a position displayed on the display section.

In this case, the printing apparatus includes the display section on which the function selecting portion can be displayed and the function selecting portion is displayed on the predetermined position. In this manner, it is easy to identify the selectable function and it is possible for the available function to be utilized with a simpler operation.

### Application Example 3

The printing apparatus according to this application example may further include a connection section to which a display terminal which can display the function selecting portion can be connected, in which the predetermined position may be a position displayed on the display terminal.

In this case, the printing apparatus includes the connection section to which the display terminal which can display the function selecting portion can be connected and the function selecting portion can be displayed on the display terminal that is connectable to the connection section of the printing apparatus. As a result, since it is easy to check the selectable functions on the display terminal and the available functions are distinctly displayed, it is possible for the available function to be utilized with a simpler operation.

### Application Example 4

In the printing apparatus according to the application example, the controller may additionally display the function selecting portion of the expanded function based on the attachment of the function expansion device.

In this case, since the function selecting portion is additionally displayed when the function expansion device is attached, it is easy to identify a selectable function.

### Application Example 5

In the printing apparatus according to the application example, the controller may enable the function selecting portion of the expanded function which is displayed in a state of not being selectable to be selected based on the attachment of the function expansion device.

In this case, the controller enables the function selecting portion of the expanded function which is displayed in a state of not being selectable to be selected based on the attachment of the function expansion device. In this manner, it is possible to recognize functions including the expanded function which the printing apparatus can have and it is possible to check whether the function is selectable.

### Application Example 6

In the printing apparatus according to the application example, the controller may include an identification section that identifies inherent identification information of the function expansion device and display the function selecting portion of the expanded function based on the identification information which is identified by the identification section.

In this case, the controller includes the identification section that identifies the inherent identification information of the function expansion device and displays the function selecting portion of the expanded function based on the identification information which is identified by the identification section. In this manner, in a case where a plurality of types of function expansion devices are connectable to the printing apparatus or in a case where multiple function expansion devices of the same type are connectable thereto, the printing apparatus can identify the connected function expansion devices. As a result, since the display more appropriately set for a target function is performed on the display terminal, it is possible for the available function to be utilized with a simpler operation.

### Application Example 7

In the printing apparatus according to the application example, the function expansion device may be at least one of an image acquiring device, a storage device, or an image transmitting device.

In this case, the function expansion device is at least one of an image acquiring device, a storage device, or an image transmitting device. Since the function expansion devices have specific functions, respectively, different operations are performed to utilize the functions, respectively. Accordingly, since the display of the expanded available function is distinctly displayed on the display section, the display terminal, or the like, there is no need to correspond to a useless display and thus it is possible for the available function to be utilized with a simpler operation.

### BRIEF DESCRIPTION OF THE DRAWINGS

The invention will be described with reference to the accompanying drawings, wherein like numbers reference like elements.

FIG. 1 is a perspective view of a printer as a printing apparatus according to Embodiment 1.

FIG. 2 is a block diagram of the printer as the printing apparatus according to Embodiment 1.

FIG. 3 is a perspective view of an image acquiring device (scanner unit) as an example of a function expansion unit.

FIG. 4 is a conceptual diagram illustrating a hierarchical configuration of a control center.

FIGS. 5A and 5B are conceptual diagrams of start screens which are displayed in a tablet terminal.

FIGS. 6A and 6B are conceptual diagrams of start screens which are displayed in the tablet terminal.

FIG. 7 is a conceptual diagram of an initial screen of the control center which is started.

FIGS. 8A and 8B are conceptual diagrams of icon regions in a case where an HDD unit is not attached.

FIG. 9 is a conceptual diagram of a copy screen.

FIG. 10 is a conceptual diagram of a scan screen.

FIG. 11 is a conceptual diagram of a file operation screen.

FIG. 12 is a conceptual diagram of an operation history display screen.

FIG. 13 is a block diagram of a printer as a printing apparatus according to Modification Example 1.

FIG. 14 is a conceptual diagram of an initial screen of the control center according to Modification Example 1 which is started.

### DESCRIPTION OF EXEMPLARY EMBODIMENTS

Hereinafter, an embodiment of the invention is embodied will be described with reference to the drawings. The following description is only an embodiment of the invention, and the invention is not limited thereto. In the following drawings, in order for the description to be easily understandable, there is a case in which a size is different from an actual size. In addition, in a coordinate system in the drawings, a Z axial direction is a vertical direction, a +Z direction is an upward direction, a Y axial direction is a frontward-rearward direction, a +Y direction is a frontward direction, an X axial direction is a horizontal direction, a +X direction is a left direction, and an X-Y plane is a horizontal plane.

### Embodiment 1

### Printing Apparatus

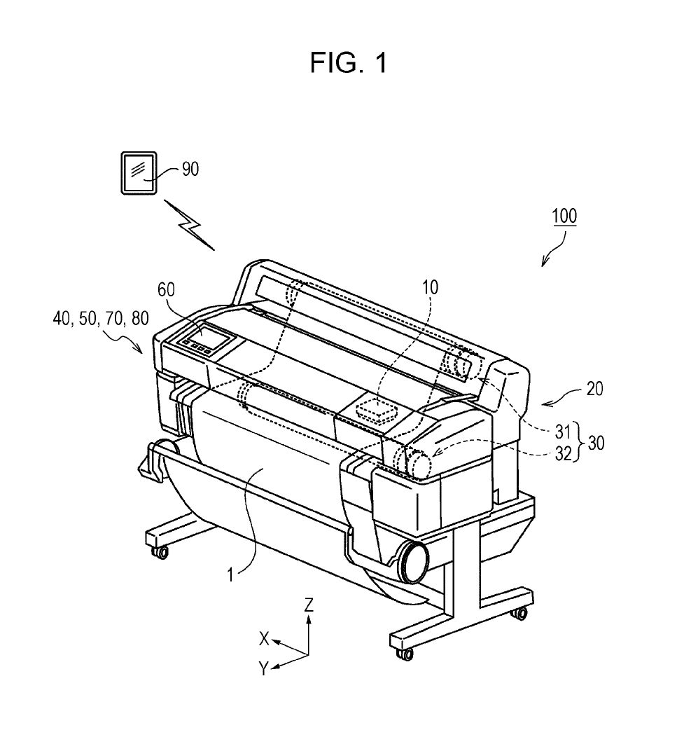

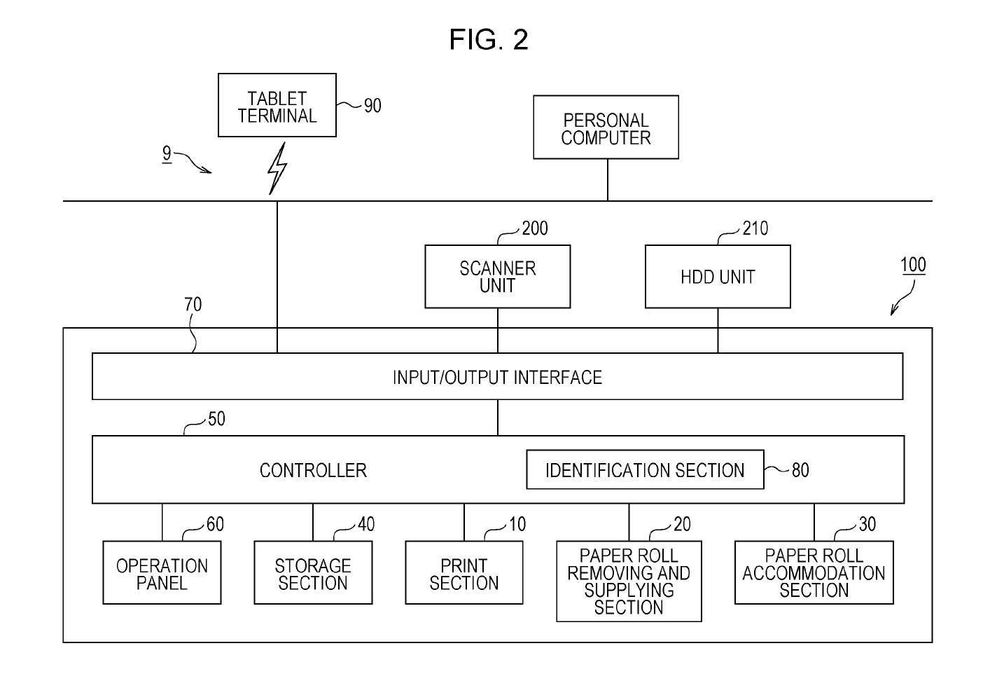

FIG. 1 is a perspective view and FIG. 2 is a block diagram of a printer 100 as a “printing apparatus” according to Embodiment 1.

For example, the printer 100 is a large-sized ink jet type printer which is able to perform printing on a printing medium of a relatively large size such as A0 size or B0 size in JIS standards. The printing medium is supplied in a state of being wound in a roll shape (hereinafter, the printing medium is referred to as a paper roll 1).

The printer 100 is configured to include a print section 10, a paper roll removing and supplying section 20, a paper roll accommodation section 30, a storage section 40, a controller 50, an operation panel 60 as a “display section”, an input/output interface 70 as a connecting section to an external device, an identification section 80, and the like.

In addition, it is possible for the printer 100 to be configured as a multifunction printer by further attaching a function expansion device (optional device). Examples of the function expansion device include an image acquiring device (for example, scanner unit 200), a storage device (for example, HDD (hard disk drive) unit 210), or the like, and the devices can be attached individually and all at the same time and the printer 100 can be configured to perform multi-functions.

In addition, it is possible for the printer 100 to be connected to a “display terminal” as a human interface, in addition to the operation panel 60, through a network 9 to which the printer 100 is connected using the input/output interface 70. A tablet terminal 90 is used as a model example of the display terminal but the display terminal is not limited thereto. As long as a Web browser is displayed, a mobile communication terminal or a personal computer may be used as the display terminal.

Wireless LAN is used as a model example of the network 9 but wired LAN or a private dedicated circuit may be used.

The print section 10 includes an ink jet head which discharges ink and prints an image on a surface of the paper roll 1, a carriage which supports the ink jet head and causes the ink jet head to move and scan the surface of the paper roll 1, and the like (not illustrated).

The paper roll removing and supplying section 20 includes a plurality of transport rollers (not illustrated) which supply the paper roll 1 accommodated in the paper roll accommodation section 30 before printing thereon to a scanning movement region of the print section 10 (or return the paper roll 1 to the paper roll accommodation section 30 side from the scanning movement region of the print section 10).

The paper roll accommodation section 30 includes a first accommodation section 31 provided in an upper rear side of an apparatus body and a second accommodation section 32 disposed on the lower side of the apparatus body. The paper rolls 1 before printing may be accommodated in the first accommodation section 31 and the second accommodation section 32, respectively. In addition, different types (material properties, sizes or the like) of paper rolls 1 can be accommodated in the accommodation sections, respectively.

Each of the first accommodation section 31 and the second accommodation section 32 includes a pair of holders which hold the paper roll 1 from both sides in an axial direction thereof and motors (not illustrated) which transmit rotative power to the pair of holders. Driving of the motors causes the paper roll 1 held by the holders to rotate and thereby, the paper roll 1 is unrolled or is rewound as necessary.

The storage section 40 is a rewritable storage medium such as a hard disk drive or a memory card. Software (a program) or the like which causes the controller 50 to operate is stored in the storage section 40.

The controller 50 includes a CPU (operation unit) and a storage unit (not illustrated) such as a RAM, and a ROM and performs centralized control of the entire printer 100 based on the software which causes the controller 50 to operate.

The operation panel 60 includes a display and an input section on which instruction to or selection on the controller 50 can be performed.

The identification section 80 is configured as a functional section of the controller 50 and can recognize connection with a function expansion device and can recognize inherent identification information of the connected function expansion device. Specifically, in a case where the function expansion device is a USB device, each function expansion device has key information such as a vendor ID, a product ID, or a serial number as the inherent identification information. The identification section 80 reads these items of information from a function expansion device connected to the input/output interface 70 and can identify a type or model number, a device number, or the like of the connected function expansion device.

### Function Expansion Device

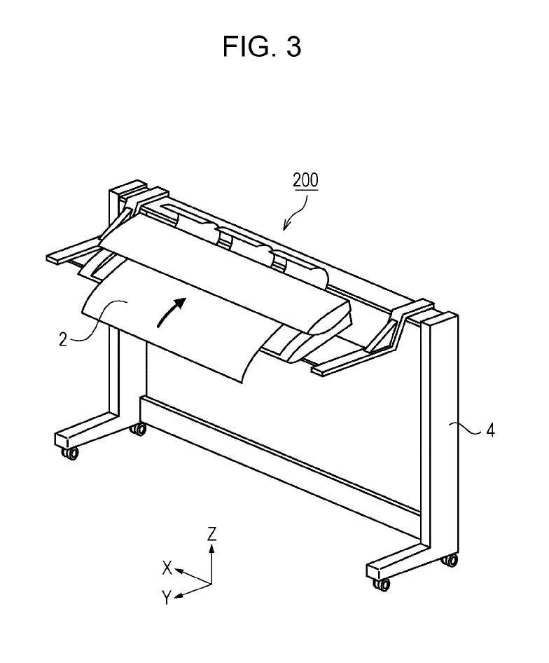

FIG. 3 is a perspective view of the scanner unit 200 as the image acquiring device as an example of a function expansion device.

The scanner unit 200 is a sheet feeding type (reading-head fixing type) image scanner in which an original document (original document 2 in FIG. 3) which has a size up to a relatively large size such as A0 or B0 can be read. The scanner unit 200 includes an original document transport mechanism which removes and supplies the original document 2, an original document reading mechanism (not illustrated) which is configured to have a light source or an image sensor, and the like, and the scanner unit is mounted on a transportable stand 4. The transportable stand 4 can be disposed behind (−Y direction) the printer 100 and supports an undersurface of a body of the scanner unit 200 such that the scanner unit 200 is positioned above the printer 100. In addition, the scanner unit 200 includes, as a USB device, a USB interface which is connected to the printer 100.

A description of a detailed configuration of the scanner unit 200 is omitted.

In a case where the scanner unit 200 is attached to the printer 100, it is possible for the printer 100 to have a copy function to print an image captured by the scanner unit 200.

In addition, in a case where, as the function expansion device, in addition to the scanner unit 200, a storage device (for example, HDD unit 210 as a USB device) which has a sufficient storage capacity (capacity that can be used for saving an image file (hereinafter, the image file is simply referred to as a file) obtained by the scanner unit 200) is attached, it is possible to have the following functions.

It is possible for the image captured by the scanner unit 200 to be saved as a file such as a JPEG file or a PDF file.

It is possible for the file to be attached to an email and to be sent to another printer 100 or the like.

It is possible for the file to be saved in a shared folder on the network 9 through the network 9.

It is possible for the file to be downloaded or to be received by email.

### Control Center

The printer 100 includes a control center as control software which causes the devices to perform functions thereof. The control center is one of programs which are operated in the controller 50 and controls and causes hardware, software, and firmware which are included in the printer 100 and the scanner unit 200 to perform functions thereof.

In addition, on the basis of a state in which the scanner unit 200 or the HDD unit 210 is connected, the control center causes operational information on these function expansion devices to be displayed on the operation panel 60 or the tablet terminal 90 and thus, it is possible to perform various operations.

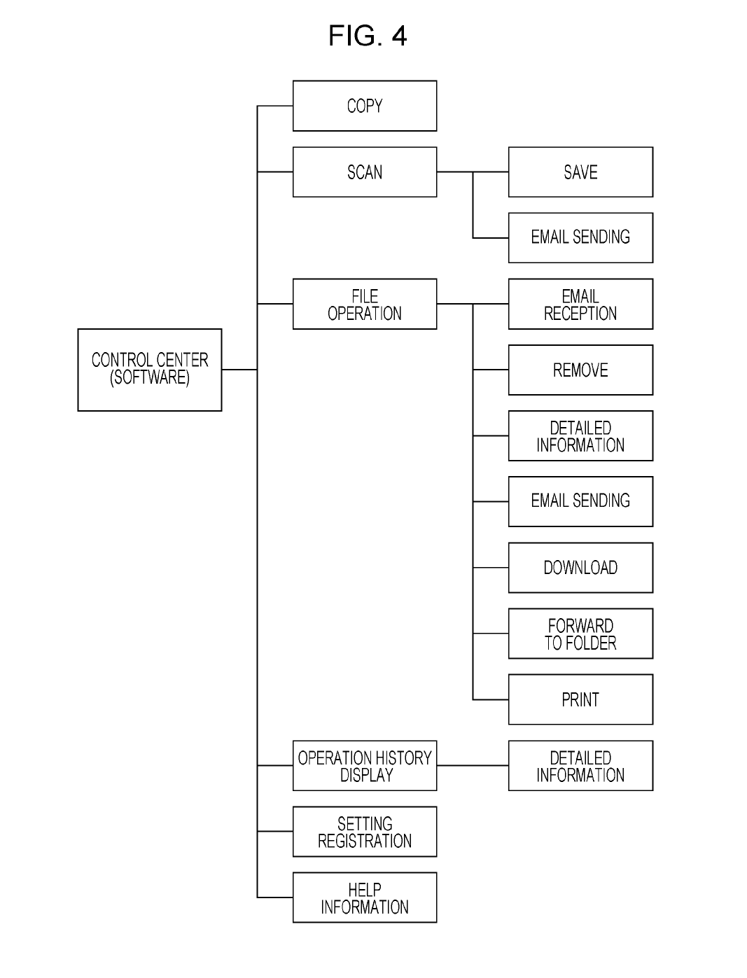

FIG. 4 is a conceptual diagram illustrating a hierarchical configuration of a control center.

The control center has functions such as copying, scanning, file operation, operation history display, setting registration, help information display, and the like.

In this manner, the scanner unit 200 as the function expansion device is attached to the printer 100 and thereby various functions are added. When the various functions are added, operations which correspond to the respective functions, an operation which selects and performs the corresponding function, a display of an operation screen thereof, or the like becomes complicated. In the present embodiment, such operations are more simply performed.

Hereinafter, a description is provided about a start method of the printer 100 or a function of the control center in a case where the scanner unit 200 as the “function expansion device (image acquiring device)” and the HDD unit 210 as the “function expansion device (storage device)” are attached to the printer 100, with reference to a screen displayed on the tablet terminal 90.

### Start of Control Center

In a case where the scanner unit 200 is attached to the printer 100, the control center can be started by access to the printer 100 from the tablet terminal 90 through the network 9. Specifically, a Web browser is first started on the tablet terminal 90. Next, an IP address which is set in the printer 100 is input to an address bar of the Web browser and a key of [Enter] or [Return] is pressed.

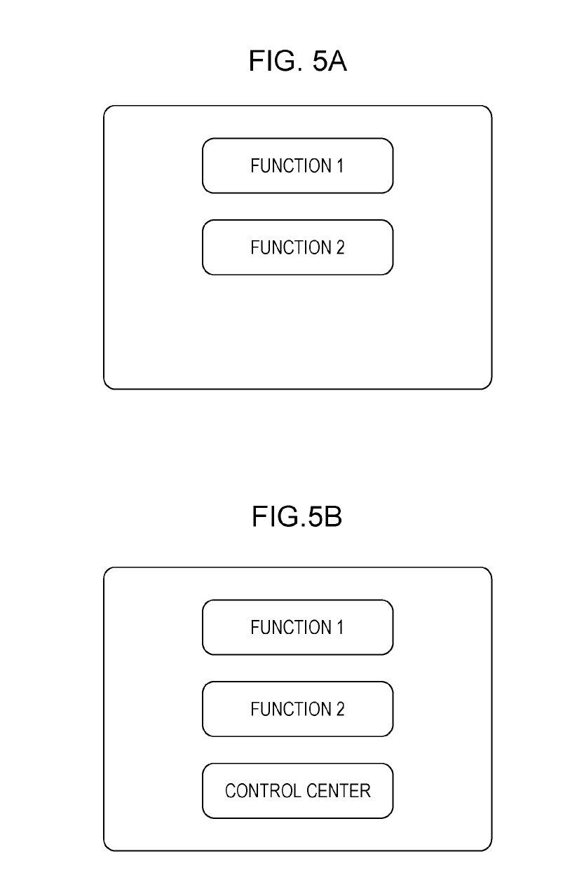

FIG. 5A is a conceptual diagram of a start screen which is displayed in the tablet terminal 90 in a case where the scanner unit 200 is not attached to the printer 100. Since the scanner unit 200 is not attached to the printer, buttons (or icons) are displayed, which can cause only available functions (illustrated as function 1 and function 2 in FIG. 5A) other than the control center to be started.

In contrast, in a case where the scanner unit 200 is attached to the printer 100 or in a case where access from the tablet terminal 90 is performed in a state in which the scanner unit 200 is attached to the printer 100, a button (or an icon) which can cause the control center to be started is also displayed as illustrated in FIG. 5B.

This is because, in a case where the scanner unit 200 is attached to the printer 100, the identification section 80 detects the attachment and the controller 50 which receives the detected result causes the start button (or icon) of the control center to be displayed as an available function.

According to the present embodiment, the start button (or icon) of the function 1 or function 2, the control center, or the like corresponds to a “function selecting portion”. The “function selecting portion” is displayed at a predetermined position which is set for each function in advance, and it is possible to recognize available functions which are set at the predetermined positions, respectively, when the predetermined position for each of the functions is confirmed, and thus, it is possible to easily recognize a selectable function. In addition, an “expanded function” means a function which becomes selectable when the printer 100 has an additional configuration such as a control center in a case where the scanner unit 200 is attached.

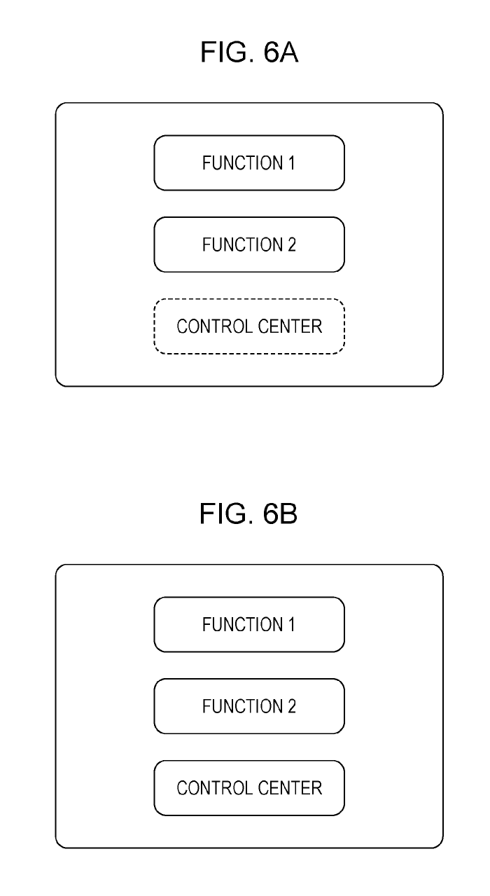

FIG. 5A illustrates that only the buttons (icons) which can cause available functions to be started are displayed, but the display is not limited thereto. Any display may be employed as long as a user who operates the tablet terminal 90 can simply recognize the availability of a function. For example, a method of display may be employed, in which an unavailable function button is grayed out. An example in FIG. 6A shows a state in which a control center start button (icon) is grayed out as a display of a state in which the button cannot be selected. The graying-out in light gray is used as a method of showing that the button cannot be selected (shown by a broken line in FIG. 6A). FIG. 6B illustrates a screen of a state in which the control center becomes selectable and can be started from a display of a state in which the control center cannot be selected, similar to in FIG. 5B.

The control center is selected on the screen in FIG. 5B or FIG. 6B and then, the control center is started.

In a case of the access from the tablet terminal 90 in a state in which the scanner unit 200 is attached to the printer 100, the control center is directly started without displaying a screen illustrated in FIG. 5A or 5B or FIG. 6A or 6B in a case where there is no function to be started other than the control center.

In this specification, “to select” an icon or button on a screen of the operation panel 60 or the tablet terminal 90 means that selection by a click or tap of a position of a target icon or button with a pointing device such as a mouse or a user's fingertip is valid.

### Initial Screen

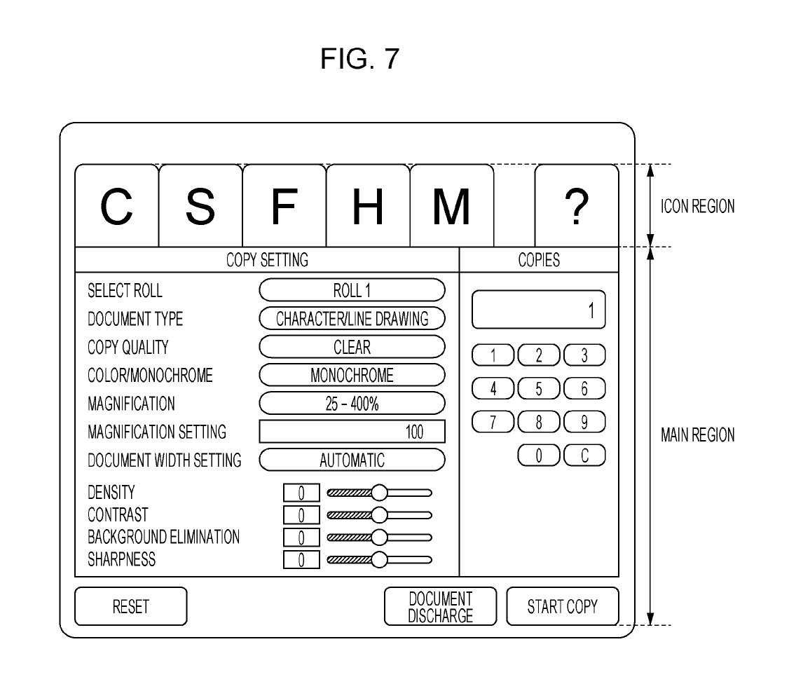

FIG. 7 is a conceptual diagram of an initial screen of the control center which is started.

The initial screen is displayed as being divided into an icon region and a main region. In addition to these regions, a banner region (region in which information which is linked to another Web site is displayed) or a footer region (region which is fixed and displayed under the main region) may be displayed.

In the icon region, icons which enables functions of the control center to be selected are displayed. Specifically, icons corresponding to respective functions of copy, scan, file operation, operation history display, setting registration, and display of help information, which are described above are displayed. FIG. 7 illustrates respective icons by copy “C”, scan “S”, file operation “F”, operation history display “H”, setting registration “M”, and display of help information “?” and it is desirable that the icons are formed of graphics from which a user can instinctively discern the functions.

As described above, even in a case where the scanner unit 200 is attached, the functions thereof are limited in a case where the HDD unit 210 is not attached. Specifically, in a case where the HDD unit 210 is not attached, only the copy function is the main function since scanned data is not saved and thus, functions of scan “S”, file operation “F”, operation history display “H”, and the like are not available.

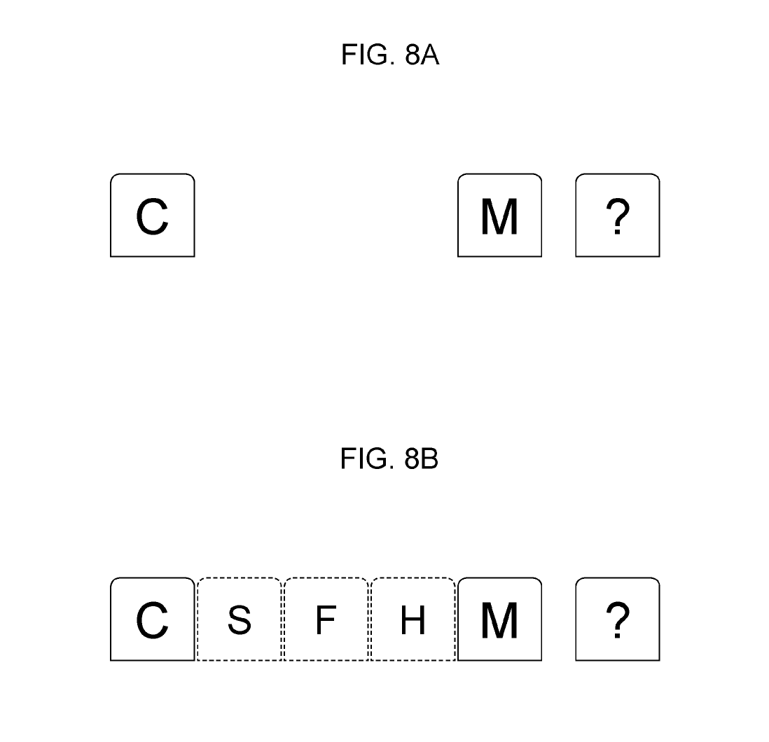

FIGS. 8A and 8B are conceptual diagrams of icon regions in a case where the HDD unit 210 is not attached.

FIG. 8A illustrates a state in which unavailable icons (scan “S”, file operation “F”, and operation history display “H”) are not displayed.

FIG. 8B illustrates a state in which unavailable icons (scan “S”, file operation “F”, and operation history display “H”) are displayed by being grayed out.

This is how the functions are displayed as not available by the controller 50 because the identification section 80 does not detect the attachment (or attaching operation) of the HDD unit 210 to the printer 100.

### Copy Screen

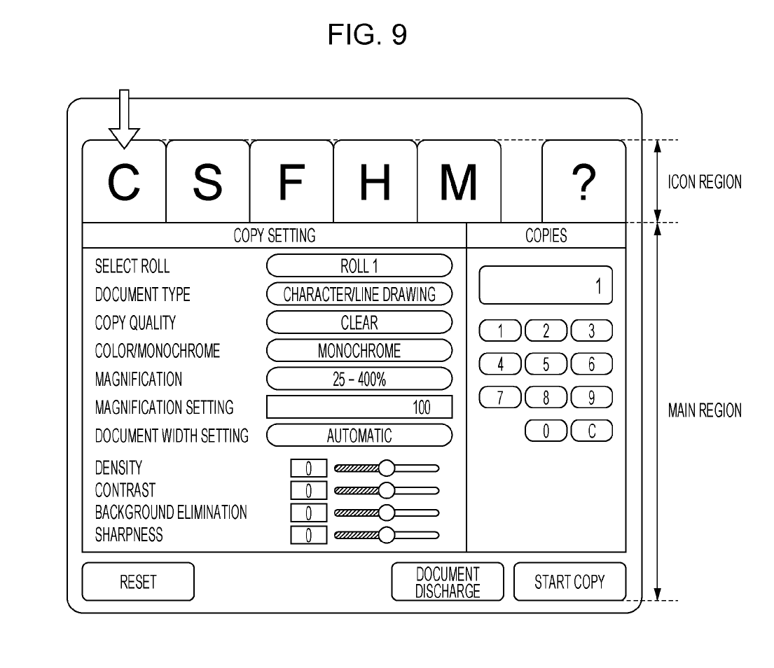

FIG. 9 is a conceptual diagram of a screen (hereinafter, referred to as a copy screen) which is displayed in a case where a copy icon “C” in the icon region is selected. The initial screen (FIG. 7) of the control center which is started may be the same as the copy screen.

A parameter which executes copying can be designated on the copy screen. When the copy screen is opened, the identification section 80 confirms the connection state of the scanner unit 200 and the copy screen is displayed as long as the scanner unit 200 is connected to the printer.

In the drawings, a bold downward arrow indicates that an icon with the arrow is selected but the arrow is not displayed on the screen.

In the main region on the copy screen, only parameters are displayed, for which settings are needed in a case where the copy function is used. On the copy screen, selection of the paper roll 1 (roll section), selection of a type of original document (document type), selection of a print quality (copy quality), selection of color or monochrome (color/monochrome), setting of magnification (magnification and magnification setting), setting of a size of an original document (document width setting), setting of density (density), setting of contrast (contrast), setting of background elimination (background elimination), setting of sharpness (sharpness), designation of the number of copies, and the like are performed. In addition, there are buttons which enables resetting of setting contents, discharge of the set original document 2, start of copying, or the like to be executed.

### Scan Screen

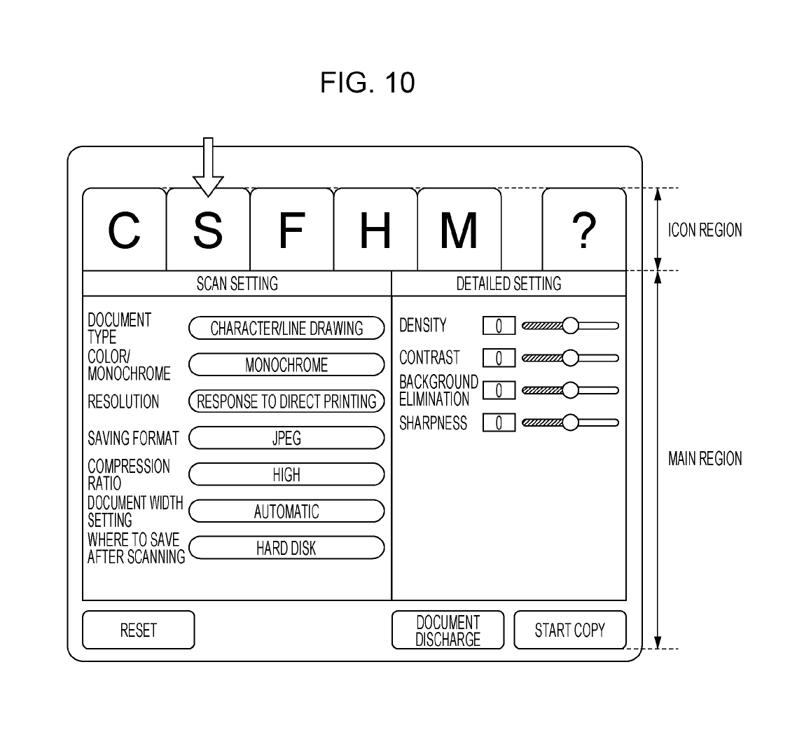

FIG. 10 is a conceptual diagram of a screen (hereinafter, referred to as a scan screen) which is displayed in a case where a scan icon “S” in the icon region is selected.

In the main region on the scan screen, only parameters are displayed, for which settings are needed in a case where the scan function is used.

On the copy screen, selection of the type of the original document 2 (document type), selection of color or monochrome (color/monochrome), selection of resolution at the time of scanning (resolution), selection of a format of saving a file (saving format), selection of a compression ratio (compression ratio), setting of a size of an original document (document width setting), selection of a save location of scan data (save location after scanning), setting of density (density), setting of contrast (contrast), setting of background elimination (background elimination), setting of sharpness (sharpness), and the like can be performed. In addition, there are buttons which enables resetting of setting contents, discharge of the set original document 2, start of scanning, or the like to be executed.

### File Operation Screen

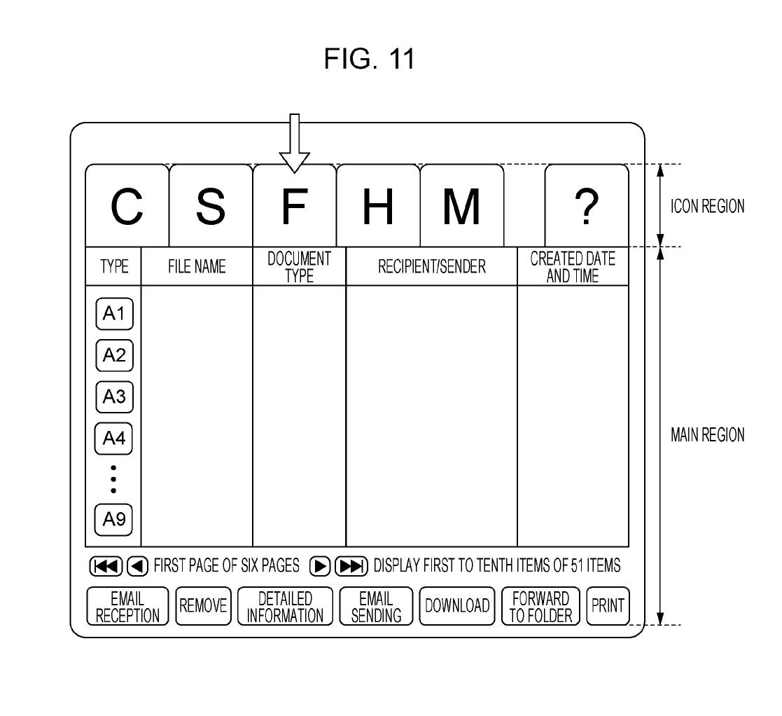

FIG. 11 is a conceptual diagram of a screen (hereinafter, referred to as a file operation screen) which is displayed in a case where a file operation “F” in the icon region is selected.

In the main region on the file operation screen, a list of files created from scanning or files received by email is displayed.

Items to be displayed as the list of files include an icon of a type of file (type), file name, document type, sender's email address in a case of receiving email or destination email address in a case of sending email, destination folder name (recipient/sender) in a case of being saved in a shared folder, created date and time, and the like.

In addition, since a list of files may fill a plurality of pages in some cases, there are buttons of next page and previous page or a section in which information on a displayed page is displayed.

In addition, on the file operation screen, there are buttons which enable email reception, removing, displaying detailed information, email sending, downloading, forwarding to a folder, printing, or the like to be executed.

Icons (A1 to A9) corresponding to the types of files are, for example, as follows. The icons include A1: file saved in the HDD unit 210 after scanning; A2: printable file saved in the HDD unit 210 after scanning; A3: saved file sent by email after scanning; A4: saved printable file sent by email after scanning; A5: file saved in a shared folder after scanning; A6: printable file saved in a shared folder after scanning; A7: file received by email; A8: printable file received by email; and A9: printable file which is received by email and is not yet printed.

It is preferable that the icons A1 to A9 are formed of graphics which are useful for a user to intuitively determine the types.

### Operation History Display Screen

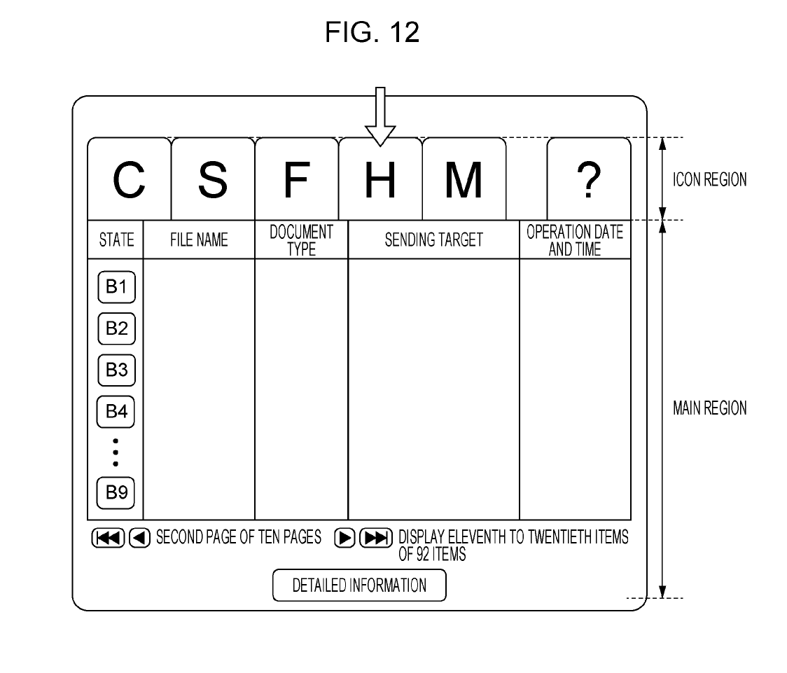

FIG. 12 is a conceptual diagram of a screen (hereinafter, referred to as an operation history display screen) which is displayed in a case where an operation history display “H” in the icon region is selected.

In the main region on the operation history display screen, a list of a history of file operations is displayed.

Items to be displayed as the list of the history of the file operations include an icon of a state of a file (state), file name, document type, destination email address in a case of sending email or destination folder name in a case of being saved in a shared folder, IP address of a personal computer to be downloaded to (recipient), operated date and time, and the like.

In addition, since a list of the files may fill a plurality of pages in some cases, there are buttons of next page and previous page or a section in which a displayed page is displayed.

In addition, on the operation history display screen, there is a button which enables detailed display to be executed.

Icons (B1 to B7) representing states of files are, for example, as follows. The icons include B1: printed file; B2: file of which printing is cancelled; B3: file sent by email; B4: file of which email sending is cancelled; B5: file forwarded to a shared folder; B6: file of which forwarding to a shared folder is cancelled; and B7: downloaded file.

It is preferable that the icons B1 to B7 are formed of graphics which are useful for a user to intuitively determine the states.

Descriptions of a setting registration screen and a help information display screen are omitted.

As described above, it is possible to achieve the following effects in the printing apparatus (printer 100) according to the present embodiment.

On the tablet terminal 90 on which the operation screen which is used to operate the printer 100 is displayed, operational information of the function expansion device is displayed at a predetermined position which is set in advance, based on the connection state of the function expansion device (scanner unit 200 or HDD unit 210) to the printer 100. Therefore, it is possible for only the sufficient operational information to be displayed for the functions which the printer 100 has. As a result, even in a case where it is possible for the printer 100 to correspond to an increase in functions, the available functions are distinctly displayed the tablet terminal 90 and thus, it is possible for the available function to be utilized with a simpler operation.

In addition, the printer 100 includes an identification section 80 that identifies identification information which is specific to the function expansion device. In addition, on the tablet terminal 90, operational information related to the function expansion device is displayed based on the identification information which is identified by the identification section 80. Therefore, in a case where a plurality of types of function expansion devices are connectable to the printer 100 or in a case where multiple function expansion devices of the same type are connectable thereto, the printer 100 can identify the connected function expansion devices. As a result, since the display more appropriately set for a target function is performed on the tablet terminal 90, it is possible for the available function to be utilized with a simpler operation.

In addition, examples of the function expansion device include the scanner unit 200 and the HDD unit 210. Since the function expansion devices have specific functions, respectively, different operations are performed to utilize the functions, respectively. According to the present embodiment, since the expanded available function is distinctly displayed on the tablet terminal 90, there is no need to correspond to a useless display and thus it is possible for the available function to be utilized with a simpler operation.

The above description is provided based on a screen displayed on the tablet terminal 90 and the same operation may be performed on the operation panel 60. Since the operation panel 60 is connected to the controller 50 without the network 9, the same screen (screen described in FIGS. 5A and 5B or in FIGS. 6A and 6B) as the screen accessed by the tablet terminal 90 using a Web browser is displayed at a stage at which the printer 100 is supplied with power. The other operation screen is the same as in the case of the tablet terminal 90.

The invention is not limited to the above embodiment and it is possible to perform various modifications or improvements to the embodiment described above. Modification examples are described below. Here, the same configuration parts as in the embodiment described above are represented by the same reference signs and description thereof is omitted.

### Modification Example 1

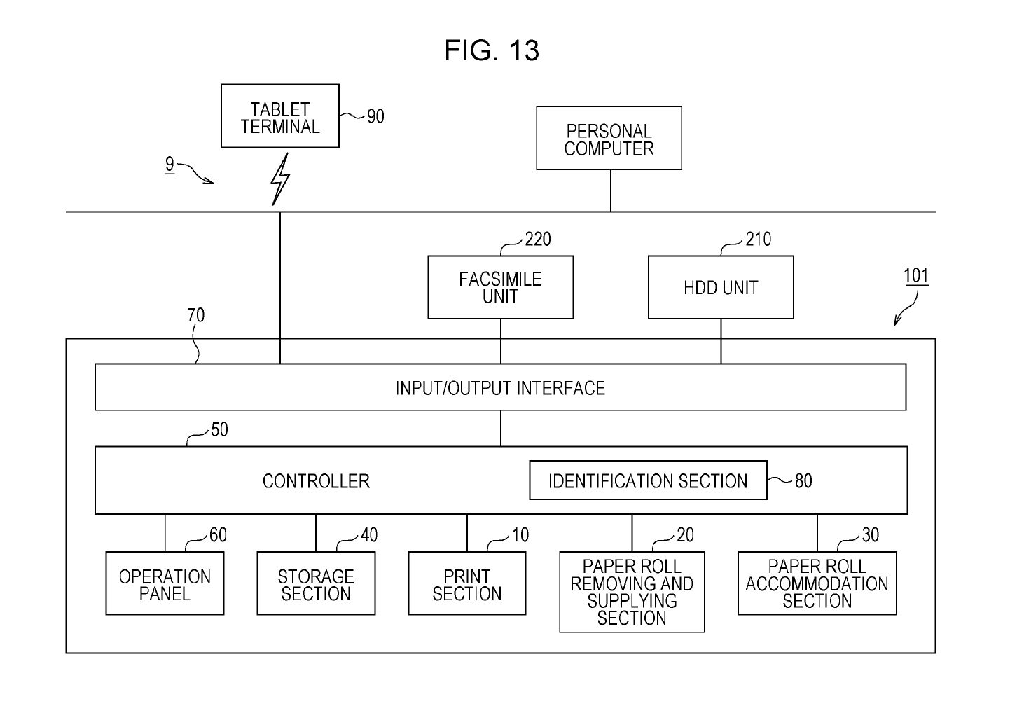

FIG. 13 is a block diagram of a printer 101 as the “printing apparatus” according to Modification Example 1.

In Embodiment 1, FIG. 2 illustrates the example in which the scanner unit 200 and the HDD unit 210 are attached as the function expansion devices; however, the function expansion device is not limited thereto, and instead of the scanner unit 200, an image transmitting device (for example, facsimile unit 220) or the like may be attached.

In a case where the facsimile unit 220 is, for example, a USB device, the identification section 80 can identify connection and disconnection of the facsimile unit 220 and a type or model number, a device number, or the like of the facsimile unit 220 which is connected from three key items of information of vendor ID, a product ID, and a serial number which the facsimile unit 220 has.

The printer 101 includes control software which utilizes the function of the facsimile unit 220 in the control center described above. Except for that, the printer 101 is the same as the printer 100.

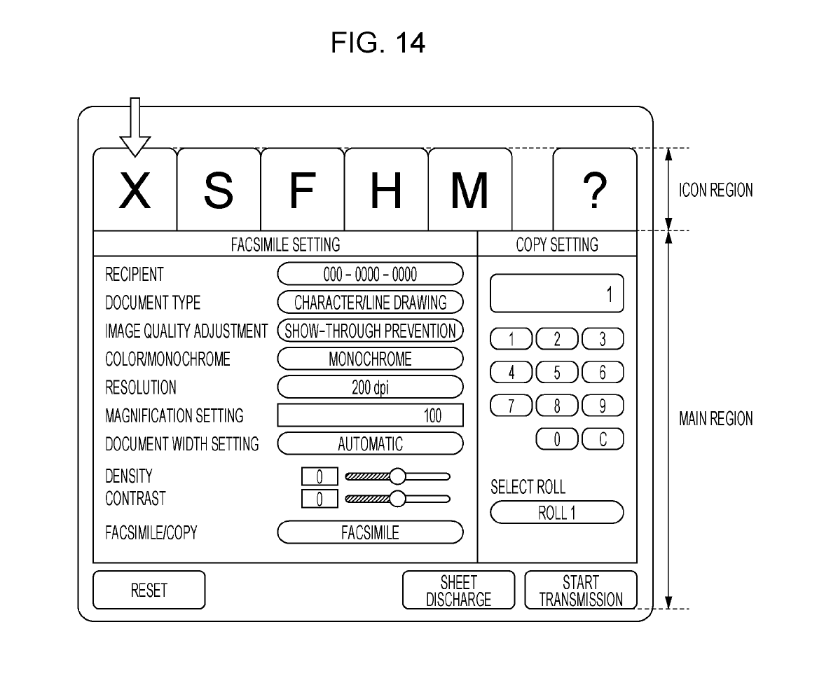

FIG. 14 is a conceptual diagram of an initial screen of the control center according to Modification Example 1 which is started.

In the icon region, a facsimile icon “X” is displayed instead of the copy icon “C” in Embodiment 1. A screen (hereinafter, referred to as a facsimile screen) displayed in a case where the facsimile icon “X” is selected is the same as in the following description.

### Facsimile Screen

In the main region on the facsimile screen, only parameters are displayed, for which settings are needed in a case where the facsimile function is used.

The facsimile screen displays a facsimile transmitting destination (recipient), selection of a type of original document (document type), selection of adjustment of an image quality such as show-through prevention or background elimination (image quality adjustment), selection of color or monochrome (color/monochrome), selection of resolution at the time of reading the original document (resolution), setting of magnification (magnification setting), setting of a size of an original document (document width setting), setting of density (density), setting of contrast (contrast), selection of facsimile transmission or copy (facsimile/copy), or the like. In a case where the copy is performed without transmission, selection of a paper roll (roll selection), designation of the number of copies, or the like can be performed. In addition, there are buttons which enable resetting of setting contents, discharge of the set original document, start of sending, or the like to be executed.

Since the function expansion devices have specific functions, respectively, different operations are performed to utilize the function, respectively. According to the Modification Example, since the expanded available functions are distinctly displayed on the operation panel 60 or the tablet terminal 90, there is no need to correspond to a useless display and it is possible for the available function to be utilized with a simpler operation.

The entire disclosure of Japanese Patent Application No.2014-110948, filed May 29, 2014 and 2015-088164, Apr. 23, 2015 are expressly incorporated by reference herein.

What is claimed is:

1. A printing apparatus comprising:
a controller that causes a function selecting portion on which a function is selectable to be displayed at a predetermined position,
wherein the predetermined position is set for each function in advance and the controller displays the function selecting portion of an expanded function at the predetermined position based on attachment of a function expansion device, in a selectable manner.

2. The printing apparatus according to claim 1, further comprising:
a display section on which the function selecting portion can be displayed,
wherein the predetermined position is a position displayed on the display section.

3. The printing apparatus according to claim 1, further comprising:
a connection section to which a display terminal which can display the function selecting portion can be connected,
wherein the predetermined position is a position displayed on the display terminal.

4. The printing apparatus according to claim 1,
wherein the controller additionally displays the function selecting portion of the expanded function based on the attachment of the function expansion device.

5. The printing apparatus according to claim 1,
wherein the controller enables the function selecting portion of the expanded function which is displayed in a state of not being selectable to be selected based on the attachment of the function expansion device.

6. The printing apparatus according to claim 1,
wherein the controller includes an identification section that identifies inherent identification information of the function expansion device and displays the function selecting portion of the expanded function based on the identification information which is identified by the identification section.

7. The printing apparatus according to claim 1,
wherein the function expansion device is at least one of an image acquiring device, a storage device, or an image transmitting device.
